(19) United States
(12) Patent Application Publication
(10) Pub. No.: US 2018/0313150 A1
(43) Pub. Date: Nov. 1, 2018

(54) Doorway Gate System

(71) Applicant: Austin Buergermeister, Matthews, NC (US)

(72) Inventor: Austin Buergermeister, Matthews, NC (US)

(21) Appl. No.: 15/499,003

(22) Filed: Apr. 27, 2017

(51) Int. Cl. E06B 11/02; E06B 9/02

(52) U.S. Cl. CPC E06B 11/022; E06B 2009/002; E06B 9/02

(57) ABSTRACT

A doorway gate system for resisting being chewed by an animal includes a barrier that has a pair of gates and a lock. The gates are slidably coupled together such that the barrier is extendable to a selected width. In this way each of the gates is selectively extended across a doorway thereby inhibiting an animal from passing through the doorway. The lock retains each of the gates at the selected width. A protective coating is positioned on the barrier and the protective coating completely covers the barrier. The protective coating is comprised of a resiliently compressible material to resist is chewed by the animal thereby enhancing a service life of the barrier.

### CROSS-REFERENCE TO RELATED APPLICATIONS

Not Applicable

### STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to gate devices and more particularly pertains to a new gate device for inhibiting a gate from being chewed by an animal.

### BRIEF SUMMARY OF THE INVENTION

An embodiment of the disclosure meets the needs presented above by generally comprising a barrier that has a pair of gates and a lock. The gates are slidably coupled together such that the barrier is extendable to a selected width. In this way each of the gates is selectively extended across a doorway thereby inhibiting an animal from passing through the doorway. The lock retains each of the gates at the selected width. A protective coating is positioned on the barrier and the protective coating completely covers the barrier. The protective coating is comprised of a resiliently compressible material to resist is chewed by the animal thereby enhancing a service life of the barrier.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a doorway gate system according to an embodiment of the disclosure.

FIG. 2 is a front view of an embodiment of the disclosure.

FIG. 3 is a cross sectional view taken along line 3-3 of FIG. 1 of an embodiment of the disclosure.

FIG. 4 is a perspective in-use view of an embodiment of the disclosure.

### DETAILED DESCRIPTION OF THE INVENTION

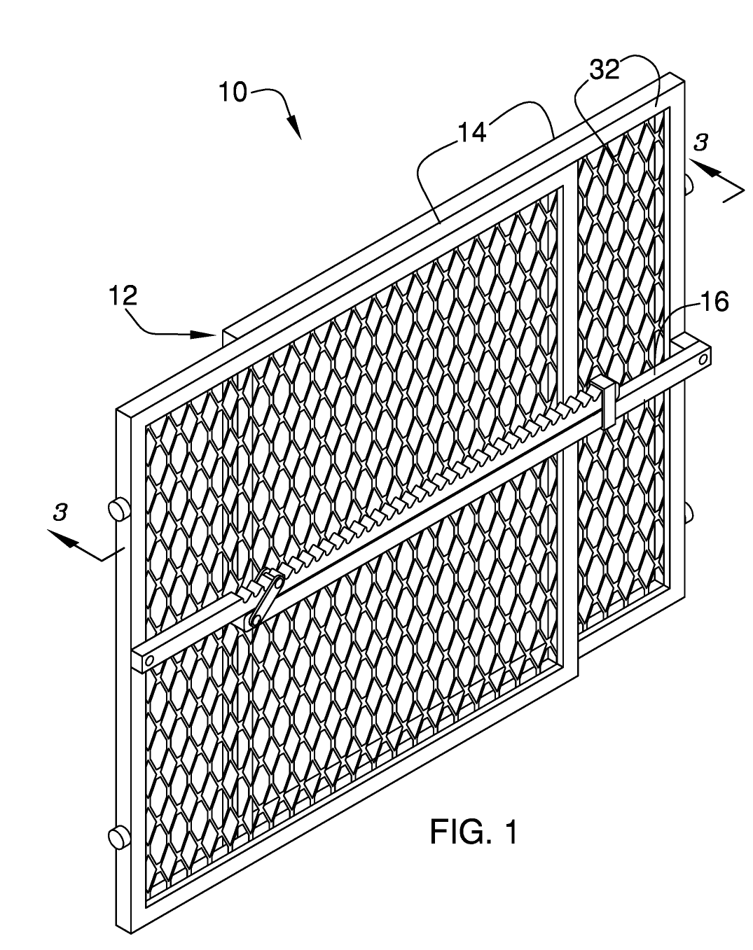

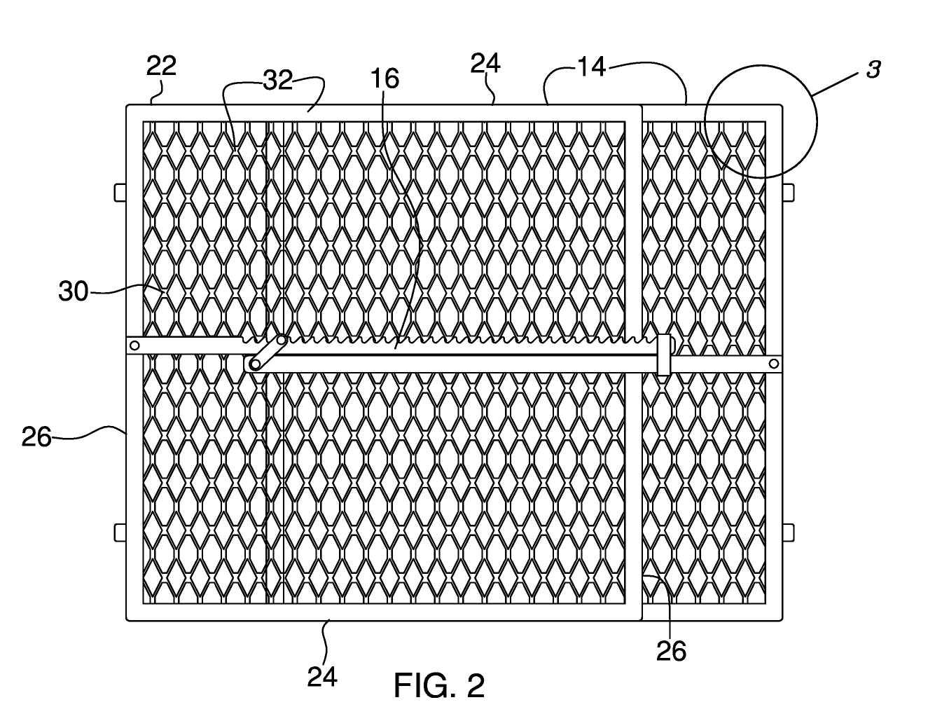

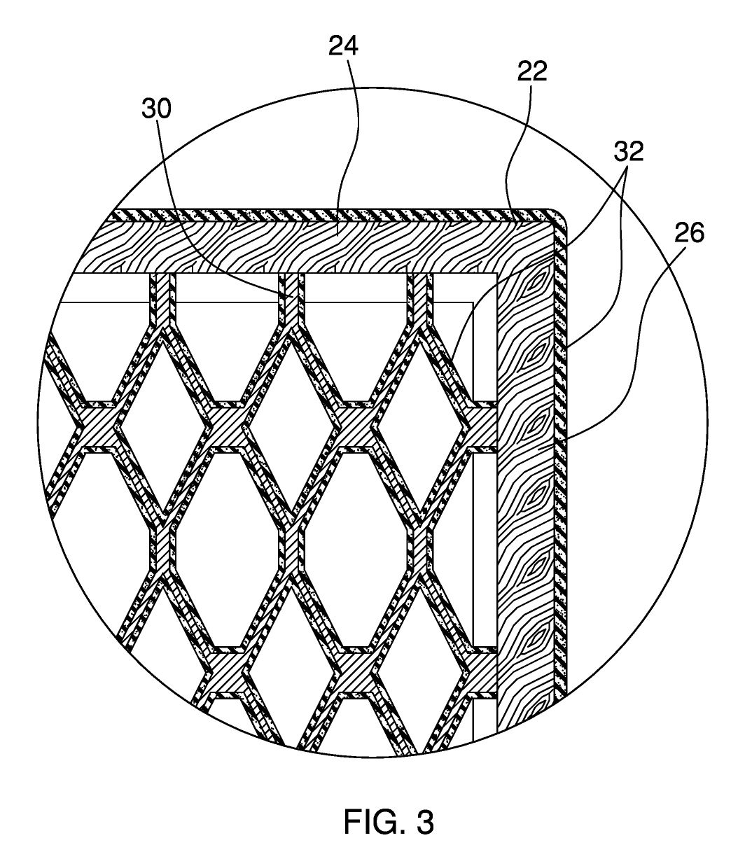

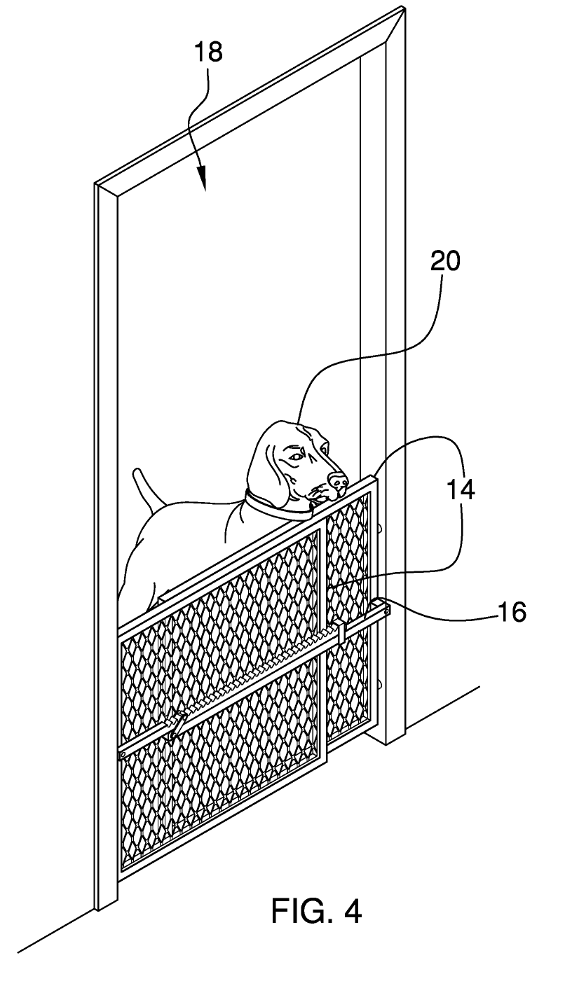

With reference now to the drawings, and in particular to FIGS. 1 through 4 thereof, a new gate device embodying the principles and concepts of an embodiment of the disclosure and generally designated by the reference numeral 10 will be described.

As best illustrated in FIGS. 1 through 4, the doorway gate system 10 generally comprises a barrier 12 that has a pair of gates 14 and a lock 16. The gates 14 are slidably coupled together such that the barrier 12 is extendable to a selected width. In this way each of the gates 14 is selectively extended across a doorway 18 thereby inhibiting an animal 20 from passing through the doorway 18. The animal 20 may be a dog or other domestic animal 20. Additionally, the barrier 12 may inhibit a child from passing through the doorway 18. The lock 16 retains each of the gates 14 at the selected width and the barrier 12 may be a baby gate of any conventional design.

Each of the gates 14 includes a frame 22 and the frame 22 corresponding to each of the gates 14 has a pair of horizontal members 24 extending between a pair of vertical members 26. The vertical members 26 corresponding to each of the gates 14 is spaced apart from each other such that each of the gates 14 has a rectangular shape. The frame 22 corresponding to each of the gates 14 has an inwardly facing surface 28. Each of the gates 14 including a mesh 30 and the mesh 30 corresponding to each of the gates 14 is coupled to and is coextensive with the inwardly facing surface 28 corresponding to each of the gates 14. In this way the mesh 30 inhibits the animal 20 and the child from passing through the frame 22 corresponding to each of the gates 14.

A protective coating 32 is positioned on the barrier 12 and the protective coating 32 completely covers the barrier 12. The protective coating 32 is comprised of a resiliently compressible material to resist being chewed by the animal 20. In this way the protective coating 32 enhances a service life of the barrier 12. The protective coating 32 completely covers the frame 22 and the mesh 30 corresponding to each of the gates 14.

The protective barrier 12 may be comprised of natural rubber, a rubber polymer or any other material that is capable of resisting being chewed by an animal 20. Additionally, the protective barrier 12 is comprised of a non-toxic material thereby inhibiting the animal 20 and the child from being poisoned by the protective coating 32. The protective barrier 12 inhibits the frame 22 from fragmenting when the animal 20 chews on the frame 22. In this way the protective barrier 12 inhibits the animal 20 from being cut or otherwise injured from fragments that would otherwise result from chewing the frame 22.

In use, the frame 22 is positioned across the doorway 18 to inhibit the animal 20 and the child from passing through the doorway 18. In this way the animal 20 and the child are retained in a selected room or other area. The protective barrier 12 inhibits the animal 20 from chewing the gates 14 and thereby damaging the gates 14. Additionally, the protective barrier 12 inhibits the frame 22 from fragmenting when the frame 22 is chewed. In this way the animal 20 is protected from injury with respect to chewing and ingesting the fragments.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A doorway gate system being configured to resist being chewed by an animal, said system comprising:
a barrier having a pair of gates and a lock, said gates being slidably coupled together such that said barrier is extendable to a selected width wherein each of said gates is configured to be extended across a doorway thereby inhibiting an animal from passing through the doorway, said lock retaining each of said gates at said selected width; and
a protective coating being positioned on said barrier such that said protective coating completely covers said barrier, said protective coating being comprised of a resiliently compressible material wherein said protective coating is configured to resist being chewed by the animal thereby enhancing a service life of said barrier.

2. The system according to claim 1, wherein each of said gates includes a frame, said frame corresponding to each of said gates having a pair of horizontal members extending between a pair of vertical members, said vertical members corresponding to each of said gates being spaced apart from each other such that each of said gates has a rectangular shape, said frame corresponding to each of said gates having an inwardly facing surface.

3. The system according to claim 1, wherein:
each of said gates includes a frame, said frame corresponding to each of said gates having an inwardly facing surface; and
each of said gates includes a mesh, said mesh corresponding to each of said gates being coupled to and being coextensive with said inwardly facing surface corresponding to each of said gates wherein said mesh is configured to inhibit the animal from passing through said frame corresponding to each of said gates.

4. The system according to claim 2, wherein said protective coating completely covering said frame and said mesh corresponding to each of said gates.

5. A doorway gate system being configured to resist being chewed by an animal, said system comprising:
a barrier having a pair of gates and a lock, said gates being slidably coupled together such that said barrier is extendable to a selected width wherein each of said gates is configured to be extended across a doorway thereby inhibiting an animal from passing through the doorway, said lock retaining each of said gates at said selected width, each of said gates including a frame, said frame corresponding to each of said gates having a pair of horizontal members extending between a pair of vertical members, said vertical members corresponding to each of said gates being spaced apart from each other such that each of said gates has a rectangular shape, said frame corresponding to each of said gates having an inwardly facing surface, each of said gates including a mesh, said mesh corresponding to each of said gates being coupled to and being coextensive with said inwardly facing surface corresponding to each of said gates wherein said mesh is configured to inhibit the animal from passing through said frame corresponding to each of said gates; and
a protective coating being positioned on said barrier such that said protective coating completely covers said barrier, said protective coating being comprised of a resiliently compressible material wherein said protective coating is configured to resist being chewed by the animal thereby enhancing a service life of said barrier, said protective coating completely covering said frame and said mesh corresponding to each of said gates.
